(19) United States
(12) Patent Application Publication
(10) Pub. No.: US 2011/0298611 A1
(43) Pub. Date: Dec. 8, 2011

(54) Apparatus and Method for an Alert Notification System

(76) Inventors: John Travis Shelton, Westfield, NC (US); Jordan J. Boyette, Westfield, NC (US); Gregory H. Williams, Kernersville, NC (US); Scott D. Elliott, Holly Springs, NC (US)

(21) Appl. No.: 13/156,581

(22) Filed: Jun. 9, 2011

Related U.S. Application Data
(63) Continuation-in-part of application No. 12/404,585, filed on Mar. 16, 2009, now Pat. No. 7,983,654.
(60) Provisional application No. 61/353,098, filed on Jun. 9, 2010.

(51) Int. Cl. G08B 1/08

(52) U.S. Cl. 340/539.11

(57) ABSTRACT

In one aspect of the teachings herein, an alert notification system provides targeted and mass notifications via wireless transmissions within a defined network coverage area served by a radio network, which may be a closed private radio network and which, in one or more contemplated embodiments, comprises an appropriately configured cellular communications network. The alert notification system includes a central monitoring station that is configured to perform one or more alert functions that are in some sense optimized for processing and responding to alerts to, among other advantages, rapidly and effectively notify persons included within a defined population of emergencies and other alert conditions.

### RELATED APPLICATIONS

This application claims priority under 35 U.S.C. 120 as a continuation-in-part of the U.S. utility application filed on 16 Mar. 2009 and identified by application Ser. No. 12/404,585 and further claims priority under 35 U.S.C. §119 from the U.S. provisional application filed on 9 Jun. 2010 and identified by App. No. 61/353,098, where both such applications are expressly incorporated herein by reference.

### FIELD OF THE INVENTION

The present invention generally relates to alert notifications, and particularly relates to reliably and quickly providing alert notifications via wireless transmissions.

### BACKGROUND

Reliably providing timely and appropriate alert notifications electronically involves a number of challenges, particularly in the context of wireless networks and more particularly when the population being alerted is potentially large and concentrated within a defined geographic area. In such cases, one faces a number of challenges, including the potential for network outages to occur from emergency traffic overloading. Even when an outright outage does not occur, ensuring deterministic performance—regarding message transmission and response times—can be quite difficult during periods of high network activity.

There are known approaches to providing communications networks for emergency services personnel; see, e.g., U.S. Pat. No. 7,263,379 to Parkulo and see U.S. Pat. No. 6,882,837 to Fernandez. Other known approaches include providing emergency prioritization within GSM-based cellular networks, such as the solution proposed in U.S. Pat. No. 7,330,710 to Xu. Still further, others have proposed dedicated networks for alerting closed populations, such as campus student bodies, albeit using limited-functionality devices and networks. As an example of this approach, one might refer to the radio receiver equipped student ID cards proposed in U.S. Patent Pub. No. 2008/0258910.

Indeed, the co-pending and commonly owned U.S. utility patent application from which this application claims priority, application Ser. No. 12/404,585, teaches an advantageous configuration for a closed, private radio network useful in providing emergency alert notifications to a student body or other defined population of persons within a defined network coverage area, such as an academic campus or office park. Yet despite the robust performance of that proposed network, there still remain opportunities to further enhance emergency alert networks and their related services, in terms of their economics, ease of implementation, transparency, and sophistication of services.

### SUMMARY

In one aspect of the teachings herein, an alert notification system provides targeted and mass notifications via wireless transmissions within a defined network coverage area served by a radio network, which may be a closed private radio network and which, in one or more contemplated embodiments, comprises an appropriately configured cellular communications network. The alert notification system includes a central monitoring station that is configured to perform one or more alert functions that are in some sense optimized for processing and responding to alerts to, among other advantages, rapidly and effectively notify persons included within a defined population of emergencies and other alert conditions.

The defined population may be, by way of non-limiting example, students and faculty in a university or employees within an office complex. In any case, the persons each have a personal transceiver, such as a dedicated two-way communication device or a cell phone that is configured for operation with the alert notification system and the central monitoring station is configured to provide one or more advantageous notification services to such persons and/or to emergency responders or appropriate authorities.

One embodiment of the invention comprises an alert notification system that is configured for targeted and mass notification of persons within a defined network coverage area, where each person has a personal transceiver configured for wirelessly communicating with the alert notification system. In an example configuration, the alert notification system comprises a central monitoring station and a radio network interface that communicatively couples the central monitoring station to a radio network, which may be considered to be included or associated with the central monitoring station.

The central monitoring station itself comprises a computer processor and memory, and it is configured to automatically generate, without need for intervention by a human dispatcher, one or more outgoing alert messages responsive to receiving one or more incoming alert messages from corresponding ones of said personal transceivers. In particular, the central monitoring station is configured to target the one or more outgoing alert messages to one or more recipients, based on at least one of: (a) determining a class or group of recipients that is flagged for receiving automatic alerts; (b) identifying particular ones of among the personal transceivers that are geographically proximate to the personal transceivers that originated the one or more incoming alert messages; and (c) identifying particular ones among the personal transceivers that are geographically within a threat path determined from location and alert timing information associated with the personal transceivers that originated the one or more incoming alert messages.

In the same or another embodiment of the invention, an alert notification system includes a central monitoring station comprising a computer processor and memory, where the central monitoring station is configured to receive one or more incoming alert messages from one or more of the personal transceivers and to generate one or more outgoing alert messages for one or more other ones of the personal transceivers responsive thereto. In particular, the central monitoring station is configured to control the alerting behavior of the one or more other ones of the personal transceivers as a function of their locations relative to the one or more personal transceivers that originated the one or more incoming alert messages.

In a non-limiting example of such operations, the central monitoring station is configured to use the location of a reporting transceiver and the locations of one or more targeted transceivers to determine the alerting behavior that is to be used by given ones of the targeted transceivers. Here, a “reporting transceiver” is a personal transceiver that originates an incoming alert message to the central monitoring station and a “targeted transceiver” is a personal transceiver that is targeted by an outgoing alert message from the central monitoring station. It is also worth noting that “location” may be used in the absolute or relative sense. For example, alerting behaviors may be determined on the locations (e.g., proximity or range) of the targeted transceivers relative to one or more reporting transceivers.

As described earlier, it is contemplated that the alert notification system includes a radio network interface that communicatively couples the central monitoring station to a radio network providing radio service coverage within the defined network coverage area, thereby permitting the central monitoring station to transmit outgoing alert messages and receive incoming alert messages. Of further note, the central monitoring station in one or more embodiments includes one or more additional interfaces, such as a computer network interface. In a non-limiting example of this configuration, the central monitoring station is configured to receive alert notifications and/or other information from authorized external parties (e.g., law enforcement, civil emergency systems, etc.). Additionally, or alternatively, the central monitoring station is configured to send outgoing alert notifications or related information to the external parties via the computer network interface.

In the same or yet another embodiment of the invention, the alert notification system includes a central monitoring station comprising a computer processor and memory, where the central monitoring station is configured to maintain a database that includes a location history for one or more of the personal transceivers. The location history comprises a fixed or rolling window of time, e.g., a log of locations tracked or otherwise recorded for some or all of the personal transceivers over the last day, week, or month. Varying degrees of temporal and positional granularity are contemplated. In at least one embodiment, personal transceiver device locations are tracked using GPS, Assisted GPS (A-GPS), radio network triangulation, dead reckoning, or some combination of two or more such approaches.

In any case, the central monitoring station of this embodiment is configured to correlate an event location and event time for a physical event of interest that occurred in or proximate to the network coverage area with the location history maintained in said database, to identify those personal transceivers, if any, that were at or proximate to the event location when the physical event occurred, and to thereby output a listing of potential witnesses for the physical event.

As a non-limiting example, a crime is committed within or nearby the network coverage area associated with the contemplated alert notification system. The central monitoring station further includes an operator interface, which may be used to input the date and time and location of the crime and/or such information is received through a computer network interface associated with or included in the central monitoring station. In either case, the central monitoring station uses the date, time, and location information to index into its location history, to identify those personal transceivers that were at or nearby the crime location, for the relevant time and date. In this regard, one or more embodiments of the database include information identifying the person associated with each personal transceiver represented in the database. Of course, making such processing and/or the outputting of witness lists available can be predicated on secure, authenticated access, using password-based access control and/or electronic certificate authentication procedures.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an example alert notification system, including or associated with a radio network configured for transmitting outgoing alert messages to personal transceivers and receiving incoming alert notifications therefrom.

FIG. 2 is a logic flow diagram illustrating an example embodiment of an alert notification method performed by the central monitoring station of FIG. 1, for example, wherein the central monitoring station is so configured for automatic alert message generation.

FIG. 3 is a logic flow diagram illustrating another example embodiment of an alert notification method performed by the central monitoring station of FIG. 1, for example, wherein the central monitoring station is so configured to control alerting behaviors of targeted personal devices.

FIG. 4 is a diagram illustrating an example format used for outgoing alert messages sent from the central monitoring station of FIG. 1, for example.

FIG. 5 is a logic flow diagram illustrating another example embodiment of an alert notification method performed by the central monitoring station of FIG. 1, for example, wherein the central monitoring station is so configured to generate potential witness lists relating to a physical event occurring within an associated network coverage.

### DETAILED DESCRIPTION

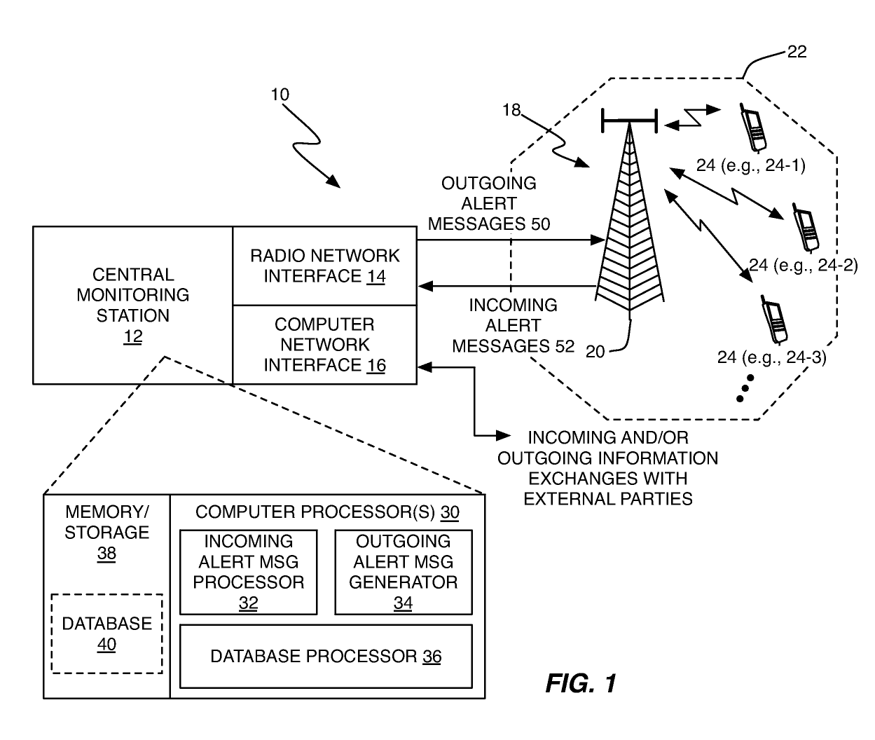

FIG. 1 illustrates an example alert notification system 10 according to one or more embodiments of the invention. The alert notification system 10 includes a central monitoring station 12 and further includes or is associated with a radio network interface (RNI) 14 and a computer network interface (CNI) 16 (e.g., an Ethernet or other communication interface circuit, which itself may include or be coupled to a wireless communications interface).

The RNI 14 communicatively couples the central monitoring station 12 to a radio network 18 which includes one or more base stations 20 (which may have backhaul and/or sidehaul communication links not explicitly shown). In one or more embodiments, the alert notification system 10 is not considered as including the radio network 18. For example, the RNI 14 may be compatible with more than one type of radio network 18 and/or may be configurable to implement different interface protocols, such that the alert notification system 10 may be provided separately from the radio network 18.

In one or more other embodiments, the alert notification system 10 may include both the central monitoring station 12 and the radio network 18. In either case, the radio network 18 provides network coverage (radio service) over at least a defined network coverage area 22, which, by way of non-limiting examples, may be a university campus, an office complex or park, or another defined area.

In this regard, in at least one contemplated embodiment, there is a defined population of users (persons) who are expected to live, work, or otherwise are expected to be present at certain times within the network coverage area 22. Note that this defined population may not constitute every single person that is physically within the network coverage area, but it may include all registered students and faculty, all employees, or all other members in defined classes or categories of persons. Each such person has an associated personal transceiver 24. Here, it should be noted that the reference number 24 is used to refer to the personal transceivers in both singular and plural senses. Numeric suffixes (i.e., −1, −2, −3, and so on) are used in instances where such use clarifies the distinction between given personal transceivers 24. Example personal transceivers 24 include dedicated pager devices that are dedicated to the task of sending and receiving alert messages within the alert notification system 10. Other examples include cellular telephones, including PDAs and smart-phone devices, which are configured for operation within the alert notification system 10. There may be a mix of personal transceiver device types.

As an example, the radio network 18 comprises a radio network based on one or more cellular communication standards (possibly with certain modifications) and the cell phones owned or assigned to the users within the defined population are configured to work with the radio network 18. In this regard the radio network 18 may be implemented as a closed, private cellular network. Privately-owned or assigned cell phones can, in such embodiments, be configured to operate as the above-discussed personal transceivers 24, and the radio network 18 may be configured so that it is accessible only to those cellular communication devices that are in some sense registered or pre-registered in the network 18.

In an example implementation, the central monitoring station 12 comprises a server or other appropriately configured computer system. As a non-limiting example, the central monitoring station 12 comprises a WINDOWS, MACINTOSH, LINUX or UNIX based computer. More broadly, at least a portion of the central monitoring station functions disclosed herein may be based at least in part on the execution of computer program instructions stored non-transiently in a computer readable medium included in or accessible to the central monitoring station 12.

Turning to specific example details illustrated in FIG. 1, the central monitoring station 12 includes one or more computer processors 30—e.g., microprocessor-based processing circuitry. At least in a logical, functional processing sense, the computer processor or processors 30 include an incoming alert message processor 32, an outgoing alert message generator 34, and a database processor 36.

The processor(s) 30 include or are associated with one or more memory 38 or other storage elements, for storing or otherwise maintaining a database 40. The database 40 will be considered in substantial detail later herein. For now, in one example, the database 40 comprises a table or other data structure that stores a listing of personal IDs and/or personal transceiver IDs, along with a location history for those devices and possibly emergency contact information, address information, class/category/group flags, etc.

Before turning to example configuration details for one embodiment of the central monitoring station 12, consider the personal transceivers 24 shown in FIG. 1. As a first point, it must be understood that at any given time there may be many such devices operating within the network coverage area 22—only a small number of devices is illustrated for simplicity. As a second point, it should be understood that the radio network 18 may include more than one base station 20, optionally with one or more radio repeaters, to ensure that reliable radio coverage is provided throughout the network coverage area 22.

As is well understood in the art of wireless network planning and design, extending good radio coverage into built-up areas in and around buildings may require multiple base stations with or without repeaters, to provide gapless, overlapping radio coverage. Further, each personal transceiver 24 need only have radio transceiver circuitry compatible with the air interface used by the radio network 18, and have processing capability compatible with the message type/formatting used by central monitoring station 12.

With the above in mind, one embodiment of the invention disclosed herein comprises an alert notification system 10 that is configured for targeted and mass notification of persons within a defined network coverage area 22. Each such person has a personal transceiver 24 that is configured for wirelessly communicating with the alert notification system 10, which comprises a central monitoring station 12 and a RNI 14.

The central monitoring station 12 comprises a computer processor 30 and memory 38. According to fixed processing circuitry, or programmable processing circuitry that is specially configured according to the execution of stored computer programs, or according to a mix of both types of circuitry, the central monitoring station 12 is configured to automatically generate, without need for intervention by a human dispatcher, one or more outgoing alert messages 50 responsive to receiving one or more incoming alert messages 52 from corresponding ones of the personal transceivers 24.

In particular, the central monitoring station 12 is configured to target the one or more outgoing alert messages 52 to one or more recipients, based on at least one of: (a) determining a class or group of recipients that is flagged for receiving automatic alerts; (b) identifying particular ones of among the personal transceivers 24 that are geographically proximate to the personal transceivers 24 that originated the one or more incoming alert messages 52; and (c) identifying particular ones among the personal transceivers 24 that are geographically within a threat path determined from location and alert timing information associated with the personal transceivers 24 that originated the one or more incoming alert messages 52. Also, as noted before, the RNI 14 couples the central monitoring station 12 to one or more radio network nodes—e.g., one or more radio base stations 20—for receiving incoming alert messages 52 and for transmitting outgoing alert messages 50.

In the above example, “recipients” may be targeted ones of the personal transceivers 24 and/or they may be external communication devices or systems associated with law enforcement, emergency responders, etc. For example, there may be a law enforcement “class” defined within the database 40, wherein the contact numbers or network addresses for one or more law enforcement officers or agencies is maintained. In this regard, the central monitoring station 12 may be configured to send outgoing alert messages 50 to such parties, in response to receiving one or more incoming alert messages 52 from one or more of the personal transceivers 24. In a particular example configuration, the central monitoring station 12 conditions its automatic sending of outgoing alert messages 50 on the number and/or timing of incoming alert messages 52.

For example, to prevent the automatic sending of outgoing alert messages 50 in response to a single, inadvertently sent incoming alert message 52, the central monitoring station 12 may be configured to count the number of incoming alert messages 52 that it receives within a given window or windows of time, or to assess the rate at which incoming alert messages 52 are being received, before logically concluding that an actual emergency event is transpiring. Not all embodiments of the central monitoring station 12 apply such conditioning.

Moreover, in at least one embodiment, the central monitoring station 12 is configured to apply such conditioning to those outgoing alert messages 50 that are directed to emergency or law enforcement personnel, but not to those outgoing alert messages 50 that are directed to any one or more of the personal transceivers 24. In at least one embodiment, the conditioning and control of automatic alerting is a user-configurable setting that can be set by an authorized user according to the needs or desires of the organization that is implementing the central monitoring station 12.

In any case, in at least one embodiment of the central monitoring station 12, the memory 38 or another storage element communicatively coupled to the computer processor(s) 30 of the central monitoring station 12 stores a database 40 that identifies groups or classes of recipients that are flagged as targets for automatic alert notifications.

Further, in embodiments of the central monitoring station 12 that work with “threat directions,” the central monitoring station 12 is configured to determine the threat direction by correlating geographic locations known for the personal transceiver(s) 24 originating the incoming alert messages 52 with reporting times known or determined for individual ones of the incoming alert messages 52. As an example, the central monitoring station 12 is configured to recognize “movement” in multiple incoming alert messages 52 by evaluating the times those messages were sent by the personal transceivers 24 that originated them (e.g., the messages can be time-stamped or the reception times can be recorded) and relating the time differences to the respective locations of the personal transceivers 24 originating such messages.

The central monitoring station 12 in one or more embodiments stores geographic information, such as map data for at least for its network coverage area, and can “project” a threat direction onto the map as a mechanism for identifying a geographic path implicated by the threat direction. In at least one such embodiment, the geographic path is determined according to default dimensions or according to known building or area characteristics, and the central monitoring station 12 is configured to identify affected personal transceivers 24 as being those having last-known locations within the path, and to generate one or more outgoing alert messages 50 targeted to at least the affected personal transceivers 24.

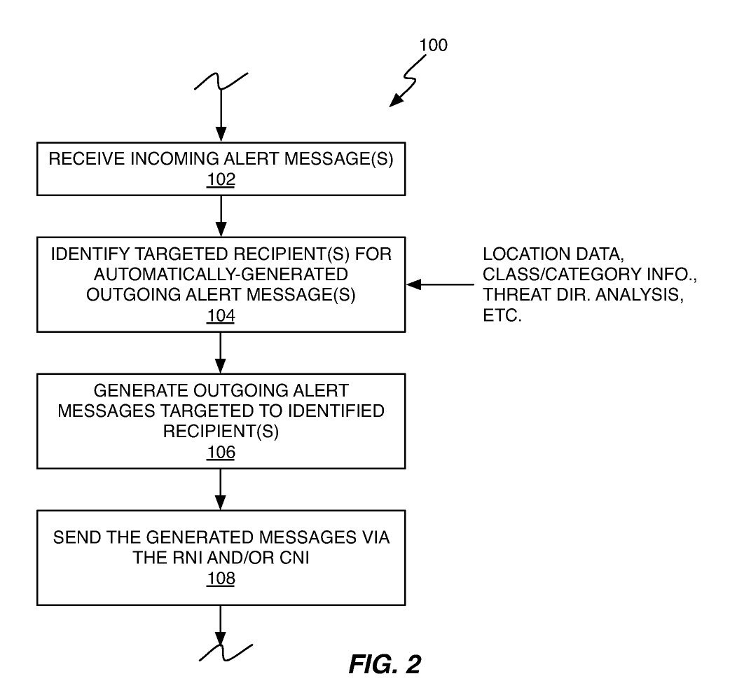

FIG. 2 illustrates a method implementation of the above central monitoring station embodiment. The method is implemented for example in the computer processor(s) 30 of the central monitoring station 12 according to the execution of stored computer program instructions, the execution of which particularly configure the 12 to carry out the disclosed processing.

The example method 100 includes receiving one or more incoming alert messages 52, e.g., one message or several received within a given time interval (Block 102). The method 100 further includes identifying one or more recipients to be targeted by automatically generated outgoing alert messages 50 (Block 104). This step can be done by identifying one or more classes or categories of recipients that have been flagged for receiving automatically generated alert messages, such as law enforcement or emergency responders whose targeted electronic communications equipment need not necessarily be considered as being included within the defined population of persons associated with the alert notification system 10. Such alerts may be sent via the CNI 16, e.g., over the web or other external communication networks. For outgoing alert messages 50 to be sent via the radio network 18, the central monitoring station 12 may identify targeted recipients based on identifying those personal transceivers 24 having current (e.g., last known or last updated) locations that are within a defined proximity of the personal transceivers 24 that originated the incoming alert messages 52. Additionally, or alternatively, the central monitoring station 12 may identify affected persons by determining a threat direction and identifying those personal transceivers 24 having current locations falling in or around a path implicated by the threat direction.

Of course, the central monitoring station 12 may be configured to automatically generate outgoing alert messages 50 that are intended for all of the personal transceivers 24, at least for certain types of emergency situations (which may be indicated within the received incoming alert messages 52). These outgoing alert messages 50 would be transferred to the radio network 18 via the RNI 14. In any case, the central monitoring station 12 automatically generates the outgoing alert message(s) 50 (Block 106), without need for intervention by a human dispatcher, and sends them via the RNI 14 and/or the CNI 16 (Block 108).

In addition to the above-described automatic alert generation, or as an alternative to such functionality, the central monitoring station 12, including its computer processor(s) 30 and memory 38, also may be configured to receive one or more incoming alert messages 52 from one or more of the personal transceivers 24 and to generate one or more outgoing alert messages 50 for one or more other ones of the personal transceivers 24 responsive thereto. For example, an incoming alert message 52 is received from a personal transceiver 24-1 and one or more outgoing alert messages 50 are targeted for personal transceivers 24-2 and 24-3 and any other ones of the personal transceivers 24 for which current location information indicates that they are within a defined proximity of the personal transceiver 24-1.

In a particular example of such a configuration, the central monitoring station 12 is configured to receive an incoming alert message 52 or messages 52 from one or more of the personal transceivers 24. Here, the central monitoring station 12 is further configured to control the alerting behavior of one or more other ones of the personal transceivers 24 as a function of their locations relative to the one or more personal transceivers 24 that originated the one or more incoming alert messages 52.

In one such embodiment, the central monitoring station 12 is configured to control the alerting behavior of the one or more other ones of the personal transceivers 24 based on being configured to: (a) generate the one or more outgoing alert messages 50 as two or more different types of alert messages 50 that prompt different alerting behaviors and target the two or more different types of alert messages 50 to particular ones of the one or more other ones of the personal transceivers 24 as a function of their respective geographic locations; or (b) include alert location information in the one or more outgoing alert messages 50 to enable individual ones of the one or more other ones of the personal transceivers 24 receiving the one or more outgoing alert messages 50 to select an alerting behavior according to a comparison of their current geographic locations with the alert location information.

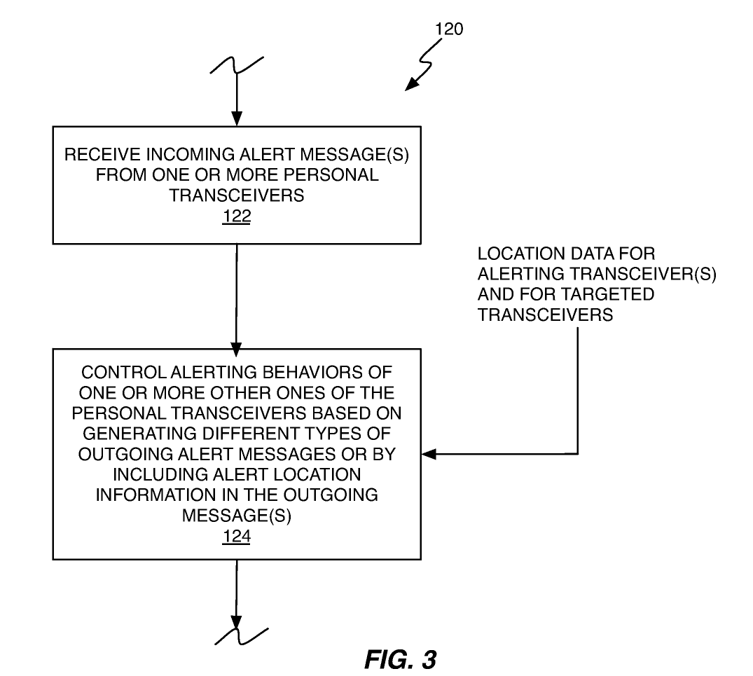

Such processing is shown in Blocks 122 and 124 of the example method 120 illustrated in FIG. 3. Additionally, such processing may include a number of variations and/or refinements. As an example, the central monitoring station 12 is configured to maintain in the memory 38 or in another associated storage device a database 40 that includes location information for each of the personal transceivers 24. In such embodiments, the central monitoring station 12 is further configured to update the location information in the database 40 based on tracking the location of each personal transceiver 24 at least within the defined network coverage area 20, or otherwise receiving such location information from individual ones of the personal transceivers 24.

In the same or another embodiment, the central monitoring station 12 is configured to cause personal transceivers 24 that are within a first defined range of the one or more personal transceivers 24 that originated the one or more incoming alert messages 52 to use a visual or tactile alarming behavior (non-audible), and to cause personal transceivers 24 that are outside that first defined range to use an audible alarming behavior instead of or in addition to visual or tactile alarming behaviors.

Further, in the same or another embodiment, the central monitoring station 12 is configured to generate the above-mentioned two or more types of outgoing alert messages 50 as messages that contain or otherwise indicate different instructions for responding, such that persons whose personal transceivers 24 are targeted by a first type of outgoing alert message 50 are provided first instructions for responding to an emergency, while persons whose personal transceivers 24 are targeted by a second type of outgoing alert message 50 are provided second instructions for responding to the emergency. Such instructions may be audio messages, textual instructions, etc. The personal transceivers 24 therefore in one or more embodiments include user interfaces (e.g., speakers, screens, etc.) for outputting such instructions.

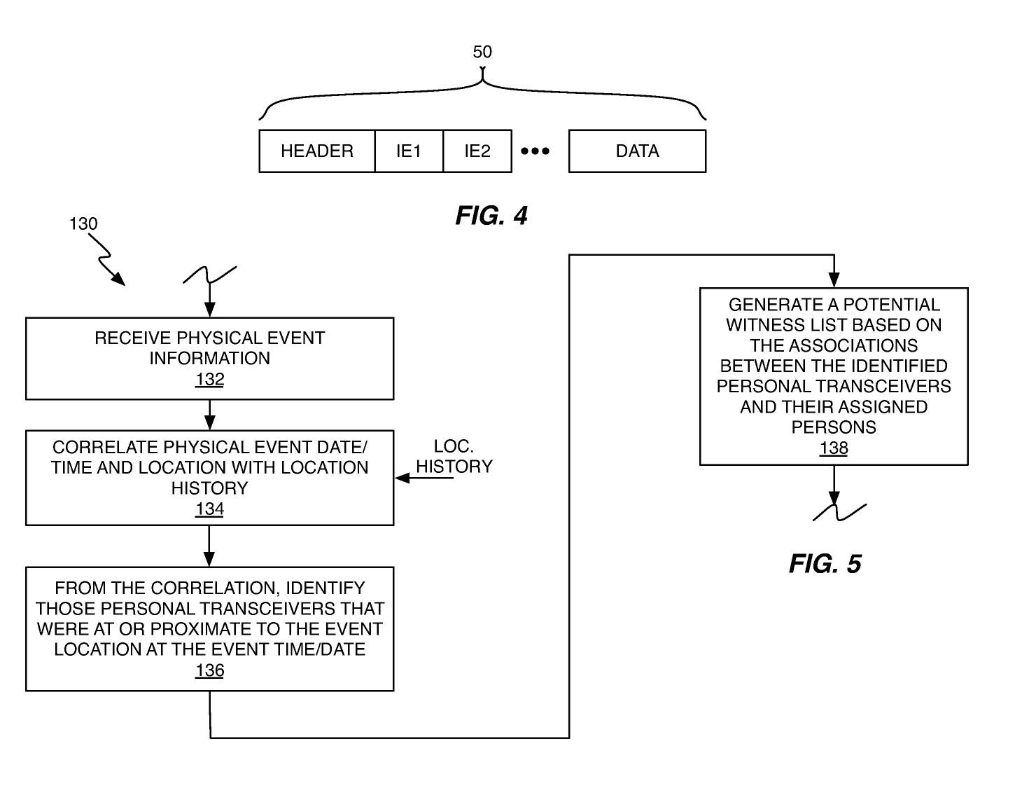

As an example of how outgoing alert messages 50 can be of different types and/or target all or only one or some of the personal transceivers 24, one may refer to the example illustration of FIG. 4. The illustrated format used for outgoing alert messages 50 includes one or more fields that can be set, e.g., according to binary patterns. In this manner, an outgoing alert message 50 includes data indicating whether it is targeted to a specific personal transceiver 24, to a group of personal transceivers 24, or is intended as a general broadcast message for all personal transceivers 24.

Of course, one of the advantages of the alert notification system 10 in one or more embodiments is instant or near-instant notification of potentially many thousands of personal transceivers 24 operating within the network coverage area 22. As such, it may be that all outgoing alert messages 50 transmitted by the radio network 18 are “broadcasted” from every base station 20 and/or from all repeater nodes, for general reception by every personal transceiver 24 that is on and within the network coverage area 22. Each such personal transceiver 24 may therefore be configured to inspect addressing or other information in each such received message to determine whether the message is targeted to it.

The non-limiting example format of FIG. 4 includes a message header, e.g., an IP-based header or other message identifier, followed by one or more information element fields (IE1, IE2, and so on) and, optionally, a data payload, which carries for example, audio or text information representing instructions for how to respond to the alert. At least one IE may be used to carry message type information, which may be used to control alerting behavior at the targeted personal transceivers 24—e.g., to control whether they give silent alert indications (tactile and/or visual) or non-silent alert indications (audible, with or without tactile/visual alerting).

Another one or more IEs can be used to carry addressing information that indicates which personal transceivers 24 are targeted by the messages. The target may be one personal transceiver 24, or multiple personal transceivers 24 having geographic or defined class/category affiliations, or may be a “flood” message intended to be received and acted on by all personal transceivers 24 within the network coverage area 22. Note that in cellular-based implementations, messages may be targeted using International Mobile Subscriber Identifiers (IMSIs) or temporary IMSIs (T-IMSIs), or by using other addressing/paging protocol provisions available within the particular cellular networking standard.

In the same or another embodiment, the central monitoring station 12 is configured to maintain a database 40 that includes a location history for one or more of the personal transceivers 24. Ideally, location information is maintained for all personal transceivers 24 that are represented in the database 40, although such information may not be updated for a given one of the personal transceivers 24 unless or until the personal transceiver 24 is turned on and operated within the network coverage area 22.

In any case, in one embodiment, the location history comprises a fixed or rolling window of time. For example, the location history for a given personal transceiver 24 comprises a series of time-stamped locations representing the determined locations of that personal transceiver 24 over a given window of time, which may be defined by a polling or reporting interval used to collect location data.

Here, the central monitoring station 12 is configured to correlate an event location and event time for a physical event of interest that occurred in or proximate to the network coverage area 22 with the location history maintained in the database 40, to identify those personal transceivers 24, if any, that were at or proximate to the event location when the physical event occurred, and to thereby output a listing of potential witnesses for the physical event. Such potential witness lists can be invaluable to law enforcement authorities or others tasked with investigating the physical event, which may be a robbery or rape for example.

Consequently, in at least one embodiment of the central monitoring station 12, it is configured to restrict access to the location history or restrict access to the listing of potential witnesses based on a security certificate authentication protocol. Here, the central monitoring station 12 is configured to authenticate an electronic security certificate as a condition to providing access. Similarly, the central monitoring station 12 may be configured to restrict access to the location history or restrict access to the listing of potential witnesses based on a password or encryption key based restriction.

Witness list generation according to the above example is illustrated by FIG. 5, which provides one embodiment of a witness list generation method 130. The illustrated method includes processing steps 132-138 (even).

Also, note that the central monitoring station 12 may include or be associated with a user interface for inputting physical event data (time/location data), or such data may be received via the CNI 16, for example. In at least one such embodiment, the central monitoring station 12 is configured to act as a secure web server accessible through the CNI 16, thereby allowing authorized persons to log into the central monitoring station 12, for performing any one or more of the following functions: generating witness lists, reviewing location history, receiving status reports, pinging or messaging particular personal transceivers 24, prompting the generation of outgoing alert messages 50 for radio transmission to some or all of the personal transceivers 24, etc.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. An alert notification system configured for targeted and mass notification of persons within a defined network coverage area, each said person having a personal transceiver configured for wirelessly communicating with said alert notification system, which comprises:
a central monitoring station comprising a computer processor and memory, said central monitoring station configured to automatically generate, without need for intervention by a human dispatcher, one or more outgoing alert messages responsive to receiving one or more incoming alert messages from corresponding ones of said personal transceivers;
said central monitoring station further configured to target said one or more outgoing alert messages to one or more recipients, based on being configured to perform at least one of: (a) determine a class or group of recipients that is flagged for receiving automatic alerts; (b) identify particular ones of among the personal transceivers that are geographically proximate to the personal transceivers that originated the one or more incoming alert messages; and (c) identify particular ones among the personal transceivers that are geographically within a threat path determined from location and alert timing information associated with the personal transceivers that originated the one or more incoming alert messages; and
further comprising a radio network interface that couples the central monitoring station to one or more radio network nodes, for receiving said incoming alert messages and for transmitting said outgoing alert messages.

2. The alert notification system of claim 1, wherein said memory or another storage element communicatively coupled to said computer processor of the central monitoring station stores a database that identifies groups or classes of recipients that are flagged as targets for automatic alert notifications.

3. The alert notification system of claim 1, wherein said central monitoring station is configured to determine the threat direction by correlating geographic locations known for the personal transceiver device or devices originating the incoming alert messages with reporting times known or determined for individual ones of the incoming alert messages.

4. An alert notification system configured for targeted and mass notification of persons within a defined network coverage area, each said person having a personal transceiver configured for wirelessly communicating with said alert notification system, which comprises:
a central monitoring station comprising a computer processor and memory, said central monitoring station configured to receive one or more incoming alert messages from one or more of the personal transceivers and to generate one or more outgoing alert messages for one or more other ones of the personal transceivers responsive thereto;
said central monitoring station further configured to control the alerting behavior of said one or more other ones of the personal transceivers as a function of their locations relative to the one or more personal transceivers that originated the one or more incoming alert messages; and
further comprising a radio network interface communicatively coupling the central monitoring station to a radio network providing radio service coverage within the defined network coverage area, for transmitting said outgoing alert messages and for receiving said incoming alert messages.

5. The alert notification system of claim 4, wherein the central monitoring station is configured to control said alerting behavior of said one or more other ones of the personal transceivers based on being configured to: (a) generate the one or more outgoing alert messages as two or more different types of alert messages that prompt different alerting behaviors and target the two or more different types of alert messages to particular ones of said one or more other ones of the personal transceivers as a function of their respective geographic locations; or (b) include alert location information in the one or more outgoing alert messages to enable individual ones of the one or more other ones of the personal transceivers receiving said one or more outgoing alert messages to select an alerting behavior according to a comparison of their current geographic locations with the alert location information.

6. The alert notification system of claim 4, wherein the central monitoring station is configured to maintain in said memory or in another associated storage device a database that includes location information for each of the personal transceivers, and wherein the central monitoring station is further configured to update the location information in said database based on tracking the location of each personal transceiver at least within the defined network coverage area, or otherwise receiving such location information from individual ones of the personal transceivers.

7. The alert notification system of claim 4, wherein the central monitoring station is configured to cause personal transceivers that are within a first defined range of the one or more personal transceivers that originated the one or more incoming alert messages to use a visual or tactile alarming behavior, and to cause personal transceivers that are outside said first defined range to use an audible alarming behavior instead of or in addition to visual or tactile alarming behaviors.

8. The alert notification system of claim 4, wherein said central monitoring station is configured to generate said two or more types of outgoing alert messages as messages that contain or otherwise indicate different instructions for responding, such that persons whose personal transceivers are targeted by a first type of outgoing alert message are provided first instructions for responding to an emergency, while persons whose personal transceivers are targeted by a second type of outgoing alert message are provided second instructions for responding to the emergency.

9. An alert notification system configured for targeted and mass notification of persons within a defined network coverage area, each said person having a personal transceiver configured for wirelessly communicating with said alert notification system, which comprises:
a central monitoring station comprising a computer processor and memory, said central monitoring station configured to maintain a database that includes a location history for one or more of said personal transceivers, said location history corresponding to a fixed or rolling window of time;
said central monitoring station further configured to correlate an event location and event time for an physical event of interest that occurred in or proximate to the network coverage area with the location history maintained in said database, to identify those personal transceivers, if any, that were at or proximate to the event location when the physical event occurred, and to thereby output a listing of potential witnesses for the physical event.

10. The alert notification system of claim 9, wherein said central monitoring station is configured to restrict access to said location history or restrict access to said listing of potential witnesses based on a security certificate authentication protocol wherein said central monitoring station authenticates an electronic security certificate as a condition to providing access.

11. The alert notification system of claim 9, wherein said central monitoring station is configured to restrict access to said location history or restrict access to said listing of potential witnesses based on a password or encryption key based restriction.
